(19) United States
(12) Patent Application Publication
(10) Pub. No.: US 2024/0052899 A1
(43) Pub. Date: Feb. 15, 2024

(54) ELECTROHYDRAULIC BRAKE UNIT

(71) Applicants: ZF Active Safety US Inc., Livonia, MI (US); ZF Active Safety GmbH, Koblenz (DE)

(72) Inventors: Blaise Ganzel, Ann Arbor, MI (US); Andreas Marx, Hartenfels (DE)

(21) Appl. No.: 18/116,509

(22) Filed: Mar. 2, 2023

(30) Foreign Application Priority Data
Aug. 12, 2022 (DE) 10 2022 120 402.2

(51) Int. Cl. F16D 65/18

(52) U.S. Cl. CPC F16D 65/18; F16D 2121/04

(57) ABSTRACT

The invention relates to an electrohydraulic brake unit (10) for a motor vehicle, comprising a pressure source (36) designed as an actuator (30), at least one brake piston (70, 80), and a brake circuit (38), which connects the pressure source (36) and the at least one brake piston (70, 80) to one another, wherein the pressure source (36), the at least one brake piston (70, 80) and the brake circuit (38) are arranged in a wheel brake. The invention moreover relates to a vehicle having such an electrohydraulic brake unit (10) and a method for activating the electrohydraulic brake unit (10).

### TECHNICAL FIELD

The invention relates to an electrohydraulic brake unit, a vehicle having such an electrohydraulic brake unit and a method for activating the electrohydraulic brake unit.

### BACKGROUND

In conventional electrohydraulic brake systems of motor vehicles, it is known to use a central actuator to detect a braking request and provide a hydraulic pressure. The hydraulic pressure here is distributed to the individual wheel brakes of the motor vehicle via pipelines.

Electromechanical brake systems (EMBs) are already adequately used. The actuators here are associated with individual wheels and are mounted directly on the brake disc. The wheel brake unit is usually installed directly on the individual wheel axle, in the inner rim area.

It is furthermore known to combine conventional electrohydraulic brake systems and EMBs with one another. For example, according to EP 0774 391 A1, the brake actuator is controlled and supplied with energy electrically. However, a hydraulic passage from the centrally arranged master brake cylinder to the wheel brakes is provided as the fallback level in the event of a partial malfunction.

This is disadvantageous in that the hydraulic equalization tank and pipework in the vehicle are sometimes difficult to reach. The maintenance of such centrally arranged brake systems is therefore extensive and costly. A disadvantage of the known EMBs is an uneven force transmission to the brake piston, resulting in uneven wear on the brake pad and the friction partner, in particular the brake disc or drum. Moreover, in EMBs, the use of high-maintenance and high-cost gears, for example planetary gears, is sometimes necessary for changing the momentum and for transmitting a force from the actuator to the brake piston. A further disadvantage in the known EMBs is that the design used does not allow for the use of an individual actuator in a fixed calliper brake.

### SUMMARY

The object of the present invention is therefore to provide an alternative brake for a motor vehicle. A further object consists in providing a brake for a motor vehicle, in which the disadvantages presented above are at least partially overcome.

This object is achieved according to the invention by the electrohydraulic brake unit. Advantageous configurations and developments of the invention are revealed in the dependent claims.

The invention relates to an electrohydraulic brake unit for a motor vehicle. The electrohydraulic brake unit comprises a pressure source, designed as an actuator, at least one brake piston, and a brake circuit, which connects the pressure source and the at least one brake piston to one another. The pressure source, the at least one brake piston and the brake circuit here are arranged in a wheel brake.

The invention moreover relates to a method for activating an electrohydraulic brake unit for a motor vehicle. The electrohydraulic brake unit here comprises a pressure source, designed as actuator, at least one brake piston, and a brake circuit, which connects the pressure source and the at least one brake piston to one another. The pressure source, the at least one brake piston and the brake circuit are arranged in a wheel brake. The actuator has a piston and the brake circuit has a working chamber and a connecting line, wherein the piston is movably arranged in the working chamber. Moreover, the connecting line connects the working chamber to the at least one brake piston. The brake circuit furthermore has a reservoir, designed as a low pressure reservoir, and a first switchable check valve. The connecting line has a second switchable check valve, by means of which the working chamber can be uncoupled from the at least one brake piston. The reservoir can be uncoupled from the connecting line by means of the first switchable check valve at a point between the second switchable check valve and the working chamber. The electrohydraulic brake unit moreover comprises a circuit board on which a pressure sensor, the first switchable check valve and the second switchable check valve are arranged. The connecting line has the pressure sensor for determining a pressure in the connecting line. The method comprises: (i) carrying out a normal operation, in which the first check valve is closed and the second check valve is open, wherein the normal operation is adapted for achieving a braking effect; (ii) carrying out an alternative operation in response to a first pressure threshold value being exceeded, in which the first check valve is open and the second check valve is closed, wherein the alternative operation is adapted for resetting the piston, whereby the piston contacts the actuator; and (iii) carrying out the normal operation in response to a second pressure threshold value not being reached, wherein the second pressure threshold value is lower than the first pressure threshold value.

The electrohydraulic brake unit is, in particular and preferably, an individual wheel brake of a motor vehicle. In particular and preferably, the brake circuit is only present in the electrohydraulic brake unit. This means that there is no connection, in particular no fluidic connection, between the brake circuit and other components of a motor vehicle—including a further electrohydraulic brake unit—located outside the electrohydraulic brake unit.

The brake is furthermore preferably designed as an electromechanical brake system (EMB). The actuator or the plunger arrangement, for example an electric motor, preferably a brushless DC electric motor, is connected to a piston or plunger here, for example via a spindle. The actuation of the actuator results in a displacement of the piston, which displacement is transferred to the brake piston, with a brake pad arranged thereon, via the brake fluid contained in the brake system. By means of the brake piston with the brake pad arranged thereon, the brake pad is brought into contact with the friction pad of a brake disc or drum and the motor vehicle is consequently braked.

It is possible to differentiate between a first brake pad and a second brake pad based on whether the electrohydraulic brake unit is configured as a floating calliper brake or as a fixed calliper brake. In the case of the floating calliper brake, the brake piston is only present on one side of the brake disc. In the case of an individual brake piston with a first brake pad arranged thereon, the first brake pad here is pressed onto the brake disc when the motor vehicle is braked and this brake disc is brought into contact with a second brake pad, wherein the second brake pad is mounted on the housing of the floating calliper brake on a side of the brake disc which is remote from the brake piston. In the case of the fixed calliper brake, at least two brake pistons are arranged on opposite sides of the brake disc and are connected to the pressure source via the brake circuit.

The piston of the actuator preferably has a smaller diameter with a comparatively long piston travel in the working chamber. For example, a ratio of the piston diameter to the piston travel is at least 1:5, preferably at least 1:8 or 1:12. The pressure of the brake fluid may thus be set more precisely.

The proposed electrohydraulic brake unit is suitable for both single-piston and multi-piston brake callipers. The advantages of the electric drive are combined with the simple and efficient hydraulic transmission. The hydraulic part of the brake system here is contained only in the respective wheel brake and is not distributed over the entire motor vehicle. The hydraulic part may therefore be encapsulated so that it remains hidden during installation in the vehicle and during operation and maintenance. Therefore, hydraulic equalization tanks and hydraulic pipework are not required in the motor vehicle. In particular, purely electrically driven vehicles may thus be run with significantly longer maintenance intervals, since the change of brake fluid is omitted. Furthermore, it is possible to select a favourable transmission ratio for the engine efficiency, wherein transmission losses are low compared to a mechanical gear. The electrohydraulic brake unit may also be produced from existing, tried-and-tested elements. These can be produced in a robust and, moreover, cost-effective manner. A further advantage is that the inner space of the actuator is filled with a liquid medium and is therefore less exposed to water ingress and corrosion. A braking request by the driver may be detected by a dry pedal force simulator. Furthermore, the brake fluid contained in the system, particular in the brake piston transmitting the brake force, serves to compensate temporary thermal influences on the actuator.

The first and the second pressure threshold value represent pressures in the brake circuit which can be detected by a pressure sensor. The first and second pressure threshold value are freely definable here. Since the pressure in the brake circuit which can be detected by the pressure sensor correlates with the piston path and/or the extent of the actuator actuation, or is proportional to these variables, the first and second pressure threshold value may also be based on the distance covered by the piston and/or based on the actuator actuation. By way of example, and preferably, the method comprises, before (ii), detecting whether a signal provided by the pressure sensor exceeds the first pressure threshold value and, after (ii), detecting whether a signal provided by the pressure sensor does not reach the second pressure threshold value.

According to an embodiment, the actuator has a piston, which is connected to the actuator in a force-fitting manner and wherein the piston and the actuator are aligned parallel to one another, preferably wherein the piston and the actuator are arranged adjacent to one another, more preferably wherein the piston is at least partially integrated in one of the brake pistons. The arrangement of the piston and the actuator, in particular an electric motor, parallel to one another, preferably adjacent to one another, enables the space-saving arrangement of the circuit in the electrohydraulic brake unit. The drive side of the actuator and the spindle—for example and in particular a ball screw—which drives the piston may be present on the same side of the electrohydraulic brake unit here. The connection of the actuator to a circuit board, and therefore possibly also to the vehicle electronics, in particular via an actuator control, is thus also simplified. The pressure source here may be designed as a single acting piston pump (single acting plunger (SAP)) or as a dual acting piston pump (dual acting plunger (DAP)). The piston may be at least partially integrated in the brake piston. A brake piston surface is preferably larger than a piston surface. An exemplary ratio may be 12:1 to 5:1. The pressure of the piston is preferably transferred to the brake piston via a brake fluid. It is thus possible to further save on space and reduce the dimensions of the electrohydraulic brake unit or to optimize these dimensions with regard to the installation space. An integrated brake control (IBC) may thus be further improved.

According to an embodiment, the electrohydraulic brake unit comprises a parking brake designed as an electromagnet, wherein the electromagnet comprises a solenoid and a core, which is movably arranged in the solenoid, wherein the core is designed to prevent the piston from resetting, preferably wherein the core is aligned parallel to the piston, and/or wherein the actuator has a gear arranged between the actuator and the piston, preferably wherein the actuator is designed as an electric motor, which is supplied with a torque sensor, and/or wherein the brake circuit has a working chamber, a connecting line and a reservoir, wherein the piston is movably arranged in the working chamber, wherein the connecting line connects the working chamber to the at least one brake piston and to the reservoir, wherein the reservoir and the brake piston are aligned parallel to one another, preferably wherein the reservoir has a vent, wherein the vent is arranged adjacent to the piston. The parking brake designed as an electromagnet provides a reliable parking lock, requires little installation space and may likewise be integrated in the electrohydraulic brake unit in a spatially optimized manner. The parking brake designed as an electromagnet is moreover easy to produce and may be easily integrated in brake systems. The parking brake designed as an electromagnet may likewise preferably be connected to a circuit board and, via this, possibly to the vehicle electronics. To this end, the electromagnet is preferably present on the spindle side of the piston. The electromagnet here comprises a solenoid and a core, which is movably arranged in the solenoid. By activating the solenoid, which takes place by means of the vehicle electronics, for example, the core may be selectively axially moved and arrested in axial positions. With a suitable arrangement of the core with respect to the piston, it is possible to prevent the piston from resetting, in particular in the direction of the bottom dead centre. The self-locking effect of the parking brake may thus be provided. The actuator may have a gear or intermediate gear arranged between the actuator and the piston. The gear may thus be arranged adjacent to a circuit board and possibly connected to the vehicle electronics via a gear control, and possibly via the printed circuit board. By choosing a suitable gear ratio, for example 2:1 to 5:1—such as 3:1—the actuator, for example an actuator designed as an electric motor, may have smaller dimensions and may therefore be provided in the electrohydraulic brake unit in a cost-effective, space-saving and spatially optimized manner. The torque provided by the actuator may therefore be smaller. Moreover, the dimensions of the spindle and/or the piston may be influenced by the gear. The spindle and the gear are preferably present as an individual component, for example, and preferably as a ball screw or ball nut arrangement (BNA). The actuator may be designed as an electric motor, which is supplied with a torque sensor. The torque sensor may possibly be connected to the vehicle electronics via the circuit board. The torque sensor may bring about improved activation of the actuator, in particular the electric motor. The brake circuit has a working chamber, a connecting line and a reservoir, wherein the piston is movably arranged in the working chamber, wherein the connecting line connects the working chamber to the at least one brake piston and to the reservoir, wherein the reservoir and the brake piston are aligned parallel to one another. A vent of the reservoir is preferably arranged adjacent to the piston, or the possibly present circuit board. The alignment of the reservoir and the brake piston parallel to one another enables the space-saving and spatially optimized accommodation thereof in the electrohydraulic brake unit. The reservoir may be supplied with a fill valve in order to enable easy filling and/or at least a partial change, at least during maintenance. The fill valve may preferably provide the only access to an otherwise encapsulated electrohydraulic brake unit.

According to an embodiment, the electrohydraulic brake unit comprises a circuit board, wherein the piston and the actuator are arranged adjacent to the circuit board, preferably wherein the pressure source has an actuator control, which is adapted for controlling the actuator, and wherein the circuit board is connected to one or more of the electromagnets of the actuator control, a control unit of the gear, the torque sensor, a pressure sensor, which is designed to ascertain a brake fluid pressure in the reservoir. The said components may thus be easily connected to a common circuit board, and possibly to the vehicle electronics. The spatial arrangement of the components of the electrohydraulic brake unit may thus be further optimized in terms of the installation space and possibly reduced in number by connecting the components to a common circuit board. Improved encapsulation of the electronics and consequently improved protection against environmental influences is thus moreover enabled. The pressure sensor may moreover be produced more cost-effectively than a force sensor.

According to an embodiment, the actuator has a piston and the brake circuit has a working chamber or plunger chamber and a connecting line, wherein the piston is movably arranged in the working chamber, wherein the connecting line connects the working chamber to the at least one brake piston. As a result of the piston movement, the brake fluid present in the working chamber and in the connecting line may thus be transferred to one or more brake pistons and these may be moved accordingly. Brake pads arranged on the brake pistons are consequently moved in the direction of the corresponding friction partner, for example the brake disc, contact this or are retracted from this. The even force distribution on the brake piston(s) which can be achieved as a result is advantageous. Uneven wear on the brake pads may thus be avoided.

According to an embodiment, the brake circuit has a reservoir and a first switchable check valve, wherein the connecting line has a second switchable check valve by means of which the working chamber can be uncoupled from the at least one brake piston, wherein the reservoir can be uncoupled from the connecting line by means of the first switchable check valve at a point between the second switchable check valve and the working chamber. This configuration of the brake system enables two different operating modes of the electrohydraulic brake unit. In normal operation, the first switchable check valve is in a closed position, this being a normally closed (NC) valve, and the second switchable check valve is in an open position, this being a normally open (NO) valve. The connection between the working chamber and the at least one brake piston which is required to generate a brake force is thus established via the connecting line. In a further alternative operating mode, the first switchable check valve is in an open position and the second switchable check valve is in a closed position. On the one hand, a fluid connection between the working chamber and the at least one brake piston is therefore interrupted. On the other, a fluid connection between the reservoir and the working chamber is established. In this regard, by moving the actuator and therefore the piston, a possible excess of brake fluid may be released into the reservoir or a possible brake fluid deficit may be taken from the reservoir. The two check valves are subsequently switched back to normal operation. The switch between normal operation and the alternative operation may be performed with the aid of the vehicle electronics, for example at regular time intervals or depending on the situation, for example each time the vehicle stops. It may thus be ensured that, in normal operation, an optimum braking effect of the electrohydraulic brake unit may be achieved at all times. Highly dynamic decreases in the clamping force, as required in ABS, are easily realized by opening the NC valve, as known from proven hydraulic systems.

According to an embodiment, the reservoir is designed as a low pressure reservoir. The term low pressure should be understood to mean that brake fluid present in the reservoir is under ambient pressure, for instance atmospheric pressure. Therefore, the reservoir comprises a fluid connection to the environment of the motor vehicle. The reservoir here preferably has means for pressure equalization with the environment. For example, the reservoir is provided with a diaphragm, arranged in the housing of the electrohydraulic brake unit, and a membrane, which is possibly present in the reservoir and is arranged between the brake fluid and the diaphragm. Alternatively or additionally, a venting screw or a venting nipple may be provided in the reservoir. Pressure equalization with the environment may therefore take place, whereby, on the one hand, a possibly high pressure in the brake circuit may be decreased and/or the piston may be easily moved. It may thus be ensured that, in normal operation, an optimum braking effect of the electrohydraulic brake unit may be achieved at all times. Heat which is possibly generated by braking and causes heating of the elements may furthermore be dissipated more easily via the brake fluid.

According to an embodiment, the electrohydraulic brake unit comprises a circuit board, on which a pressure sensor, the first switchable check valve and the second switchable check valve are arranged, wherein the connecting line has the pressure sensor for determining a pressure in the connecting line. To this end, the circuit board is preferably arranged within the electrohydraulic brake unit. By means of coils arranged on the circuit board, the check valves may be readily activated by the vehicle electronics and the pressure within the brake circuit may be detected and possibly regulated by means of the check valves and/or an actuation of the actuator. An electrohydraulic brake unit may thus be provided, which, as such, may be installed in the motor vehicle, wherein, apart from the mounting on the chassis of the motor vehicle, it is only necessary to establish electrical connections between the circuit board and the vehicle electronics, in particular a control unit. Hydraulic equalization tanks and hydraulic pipework in the motor vehicle are therefore not required. One or more further sensors may be mounted in the electrohydraulic brake unit and, for example, connected to the circuit board, for example in order to provide the vehicle electrohydraulic brake unit with information relating to the operating state, preferably relating to the functionality of individual elements of the electrohydraulic brake unit brake unit. The vehicle electronics preferably provide corresponding driving and braking assistance functions. These driving and braking assistance functions are used, amongst other things, for autonomous or partially autonomous driving and also in the event of heavy braking.

According to an embodiment, the connecting line has a pressures sensor. The pressure sensor here may be configured as an absolute pressure sensor or a differential pressure sensor, or relative sensor. The pressure sensor here is preferably arranged on the connecting line in such a way that the pressure in the brake circuit and the change in this pressure, possibly in relation to the atmospheric pressure, which is caused by a movement of the piston, may be determined at all times. Further pressure sensors may be provided in the brake circuit, for example for more precise pressure determination and/or as redundancy sensors. During normal operation, the brake pressure for each individual wheel brake may therefore be determined and optimally controlled at all times. The electrohydraulic brake units are preferably activated by vehicle electronics, in particular a control unit, in the motor vehicle in such a way that all wheel brakes provide an identical brake pressure. An even braking effect is thus achieved and it is easier for the driver to control the vehicle, even during emergency braking.

According to an embodiment, the electrohydraulic brake unit is designed as a floating calliper brake or a fixed calliper brake. The electrohydraulic brake unit is preferably designed as a fixed calliper brake, wherein at least two, for example four, six or eight, brake pistons are arranged symmetrically on the brake disc in pairs; more, preferably wherein each of the brake pistons is in communication with the working chamber via the connecting line for actuation by means of the actuator. It is therefore possible to achieve a distributed and optimum braking effect at multiple points and on both sides of the brake disc.

According to an embodiment, the electrohydraulic brake unit is designed as a closed system. The closed or encapsulated system here preferably merely has mounting means for mounting the electrohydraulic brake unit on the motor vehicle and electrical contacts for the electrical connection to the circuit board of the electrohydraulic brake unit, for example. The circuit board here may provide an electrical connection of one or more components, preferably the actuator, the check valves and the pressure sensor, to vehicle electronics, in particular to a control unit. Hydraulic lines and/or tanks in the closed system here are present in such a way that brake fluid does not pass to the environment or the brake fluid does not absorb water, for example in the form of atmospheric moisture. The electrohydraulic brake unit may thus be removed or installed as such and/or its maintenance may be simplified.

According to an embodiment, each wheel of the vehicle is supplied with the electrohydraulic brake unit. The activation of the electrohydraulic brake units preferably takes place by means of vehicle electronics, in particular a control unit, of the vehicle in such a way that, in the event of a brake application, all wheels of the vehicle are subjected to a substantially identical brake pressure. An even braking effect is thus achieved and it is easier for the driver to control the vehicle.

The brake system is, in particular, an integrated brake system. An integrated brake system is a structural unit which combines a plurality of functions in a compact design. It is clear that further brake systems may be integrated in the motor vehicle; for example and preferably, the electrohydraulic brake unit may comprise a second pressure source, designed as an actuator, at least one second brake piston and a second brake circuit, which connects the second pressure source and the at least one second brake piston to one another, wherein the second pressure source, the at least one second brake piston and the second brake circuit are arranged in the wheel brake. Therefore, a second, for example auxiliary or redundancy, brake system may be present.

The vehicle electronics, in particular the control unit, further preferably provides corresponding driving and braking assistance functions. These driving and braking assistance functions are used, amongst other things, for autonomous or partially autonomous driving and also in the event of heavy braking.

The invention furthermore relates to a vehicle, comprising an electrohydraulic brake unit according to the invention. The vehicle is preferably a motor vehicle. Examples of motor vehicles are cars, lorries, buses, agricultural machines or motor bikes. The vehicle is more preferably a car.

### BRIEF DESCRIPTION OF THE DRAWINGS

The invention is explained by way of example and in detail below with the aid of several figures, in which:

FIG. 1 shows a schematic illustration of an electrohydraulic brake unit for a motor vehicle according to a first embodiment;

FIG. 2 shows a schematic view of an electrohydraulic brake unit for a motor vehicle according to a second embodiment;

FIGS. 3a and 3b show exemplary operating states of the electrohydraulic brake unit 10 of the first embodiment; which is designed as a floating calliper brake; and

FIG. 4 shows a sectional view of an electrohydraulic brake unit 10 for a motor vehicle according to a third embodiment.

### DESCRIPTION

Identical subject matters, functional units and comparable components are denoted by the same reference signs across all figures. These subject matters, functional units and comparable components are designed to be identical in terms of their technical features unless the description explicitly or implicitly reveals otherwise.

In the brake systems known from the prior art, which are based on the use of EMB, actuators act on the brake pistons directly or via other mechanical components, in particular gears. The even transmission of the force applied to the brake piston by the actuator has proven problematic here. A hydraulic connection between the actuator and brake piston is proposed below, whereby structural disadvantages of the EMB proposed in the prior art are eliminated.

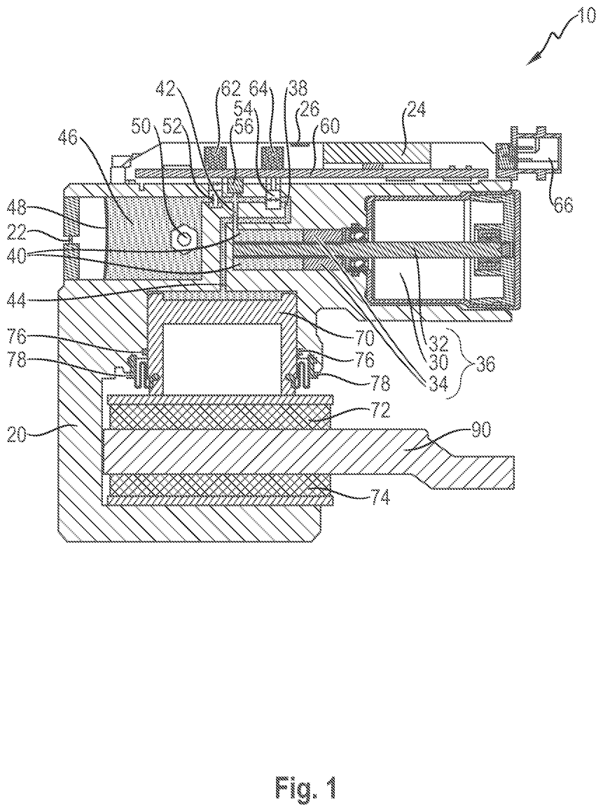

FIG. 1 shows a schematic illustration of an electrohydraulic brake unit 10 for a motor vehicle according to a first embodiment. The electrohydraulic brake unit 10, which, purely by way of example, is designed as a floating calliper brake in the present case, is a component of a brake system (not shown) of a motor vehicle (likewise not shown). The brake system is preferably an integrated brake system, in which a plurality of functions are combined in a compact design.

In the brake system, such an electrohydraulic brake unit 10 is mounted on each wheel of the motor vehicle, wherein the brake unit 10 is electrically connected to a control unit (not shown here) via connections 66. The control unit is preferably a control unit which is designed as a driver assistance system and which provides for activation of the electrohydraulic brake unit 10 in conjunction with the drive unit of the motor vehicle. The activation here may take place via a pressure sensor 56 and possibly further sensors (not shown here). The control unit preferably moreover provides corresponding driving and braking assistance functions which are used, amongst other things, for autonomous or partially autonomous driving and during braking.

The electrohydraulic brake unit 10 comprises a housing 20, in which a pressure source 36, designed as an actuator 30, a brake piston 70 and a brake circuit 38 are encapsulated in such a way that the brake circuit 38 is in non-fluidic communication with the surrounding environment of the electrohydraulic brake unit 10, in particular the further components of the motor vehicle, including the further electrohydraulic brake units 10.

All components of the electrohydraulic unit 10 are therefore present in an individual wheel brake so that they can be activated via a control signal line between the electrohydraulic brake unit 10 and the control unit of the motor vehicle. This enables simplified activation of the electrohydraulic brake unit 10, or its various components, along with reduced installation space for additional control signal lines. Hydraulic connections are not distributed over the entire motor vehicle, but are instead restricted to the electrohydraulic brake unit 10, thus resulting in the brake unit 10 being suitable for both single-piston and multi-piston brake callipers alike and, furthermore, less wear on the above components as well as longer maintenance intervals for the brake system overall. The electrohydraulic brake unit 10 may also be produced from existing low-maintenance and cost-effective components. A braking request by the driver may be detected by a dry pedal force simulator, for example.

The actuator 30 (shown in FIG. 1), which is designed by way of example as a plunger arrangement, drives a spindle 32 with a piston 34, designed as a plunger, for movement in a working chamber 40. The extension of the piston 34 brings about a compression of the brake fluid present in the working chamber 40. The brake fluid which is compressed in this way flows through a connecting line 42, 44 of the brake circuit 38, which connects the working chamber 40 to the brake piston 70, which is movably arranged in the housing 20, and thus presses the brake piston 70, which is surrounded by a sealing ring 76 and sealed by means of a pleat seal 78, onto a brake disc 90 by means a first brake pad 72 arranged on said brake piston. The brake disc 90 is in turn pressed against a second brake pad 74, which is mounted on the housing 20 in a fixed manner. As a result of the frictional forces generated here, the rotational movement of the brake disc 90 is counteracted and the motor vehicle is consequently braked.

Equally, in addition to expanding the brake fluid present in the working chamber 40 and in the connecting line 42, 44, a resetting of the piston 34 also causes the brake fluid to return into the expanding working chamber 40, whereby the brake piston 70 is also retracted from the brake disc 90.

FIG. 1 furthermore reveals that the brake circuit 38 has a reservoir 46 with brake fluid contained therein and a first switchable check valve 52. A second switchable check valve 54, by means of which the working chamber 40 can be uncoupled from at least one brake piston 70, is arranged on the connecting line 42, 44. Moreover, the reservoir 46 can be uncoupled from the connecting line 42, 44 by means of the first switchable check valve 52 at a point between the second switchable check valve 54 and the working chamber 40. Depending on the switching state of the two check valves 52, 54, the working chamber 40 of the piston may be selectively coupled to either the reservoir 46 or the brake piston 70 via the connecting line 42, 44, or uncoupled from both. A pressure sensor 56 is furthermore mounted on the connecting line 42, 44, between the first switchable check valve 52 and the second switchable check valve 54. The pressure sensor 56 detects the pressure acting on the brake disc 90 on the basis of a pressure change in the brake fluid and transfers corresponding signals to the control unit of the motor vehicle, which signals are used by the control unit to activate the electrohydraulic brake unit 10.

The use of the reservoir 46, the first and second check valve 52, 54 and the pressure sensor 56 enables substantially three operating states of the electrohydraulic brake unit 10, depending on the switching state of the first and second check valve 52, 54. These three operating states—a so-called normal operation, an alternative operation and a pressure equalization operation—are explained in more detail below.

During normal operation, the electrohydraulic brake unit 10 may be used for the usual braking of the motor vehicle. In this case, the first switchable check valve 52 is closed as an NC valve and the second switchable check valve 54 is open as an NO valve. The reservoir 46 is thus disconnected from the connecting line 42, 44 in such a way that the brake fluid, as mentioned above, may only be moved between the working chamber 40 and the brake piston 70 according to the movement direction of the actuator 30. As a result, the brake piston 70, with the first brake pad 72 mounted thereon, is moved either in the direction of the brake disc 90 or away from this brake disc. If the first brake pad 72 is pressed against the brake disc 90, the brake disc 90 is in turn pressed against the second brake pad 74 mounted on the housing 20, whereby the rotational movement of the brake disc 90 is counteracted by force and the motor vehicle is therefore also braked.

During normal operation of the electrohydraulic brake unit 10, once a braking effect has been called for multiple times, a partial redistribution of the brake fluid between the working chamber 40 and the brake piston 70 may be realized in that only some of the brake fluid is returned to the starting position when the piston 34 is retracted. Therefore, a certain residual quantity of brake fluid remains on the brake piston 70.

As a result, with multiple successive brake applications, the piston 34 has to cover a shorter extension distance for a later brake application than for one of the earlier brake applications. Consequently, with multiple successive brake applications, the quantity of brake fluid moved by the piston is smaller each time, whereby the braking effect decreases. Moreover, the determination of the pressure by the pressure sensor 56, and consequently also the activation of the electrohydraulic brake unit 10 by the control unit, becomes less precise.

During the alternative operation, the first switchable check valve 52, 54 is open and the second switchable check valve 52, 54 is closed. A connection between the working chamber 40 and the reservoir 46 is thus established, whilst the connection between the working chamber 40 and the brake piston 70 is interrupted.

In the present case, the reservoir 46 is designed as a low pressure reservoir for the brake fluid. The brake fluid present in the reservoir 46 is separated from the housing 20 here by a membrane 48. Moreover, a venting screw is 50 is provided on the reservoir 46 in such a way that the extension of the piston 34 results in the compression of the brake fluid and moves it into the reservoir 46 via the connecting line 42, 44. Diaphragms 22 are furthermore provided on the housing 20 for pressure equalization with the environment. The membrane 48, a diaphragm 22 provided in the reservoir 46 and the venting screw 50 here enable the intake of brake fluid, whilst preventing brake fluid from escaping from the housing 20 and into the reservoir 46. On the other hand, the retraction of the piston 34 results in brake fluid being taken from the reservoir 46.

With multiple successive brake applications, for example the motor vehicle has been braked five times in each case and the motor vehicle has stopped, or when a predetermined maximum or first pressure threshold value has been exceeded, the check valves 52, 54 are brought into the alternative position and the working chamber 40 is filled by retracting the piston 34, preferably completely. Then, for example when a predefined minimum or second pressure threshold value has not been reached, the two check valves 52, 54 are brought back into the normal position so that a full braking effect may be provided by the electrohydraulic brake unit 10.

During the pressure equalization operation, both check valves 52, 54 are simultaneously open. Both the brake piston 70 and the piston 34 are therefore in fluidic communication with the reservoir 46 via the connecting line 43, 44 and the brake fluid contained therein. In the event of a local temperature increase at the brake piston 70 and/or the piston 34, for example as a result of heavy and/or frequent braking, heat may thus be transferred, via the brake fluid, to brake fluid present in the reservoir 46 and released effectively to the environment. As a result, (possibly local) overheating of the electrohydraulic brake unit 10 may be avoided.

With regard to the design of the electrohydraulic brake unit 10, FIG. 1 furthermore reveals that the two check valves 52, 54 and the pressure sensor 56 are mounted directly on a circuit board 60 with connections 66 for vehicle electronics (not shown). By means of the circuit board 60 and, likewise, coils 62, 64 which are mounted thereon, the two check valves 52, 54 may be switched into the open or closed position independently of one another. Moreover, the sensor data obtained by the pressure sensor 56 is acquired and transferred to the vehicle electronics. The actuator 30 may equally also be actuated by the vehicle electronics via the circuit board 60. The circuit board 60 here is accommodated entirely in the housing 20 of the electrohydraulic brake unit 10 or fully integrated therein and may be temperature-controlled via a cooling unit 24 provided on the housing 20. The circuit board 60 here, with the exception of the connections 66, is likewise accommodated in the encapsulation, whereby it is better protected from environmental influences.

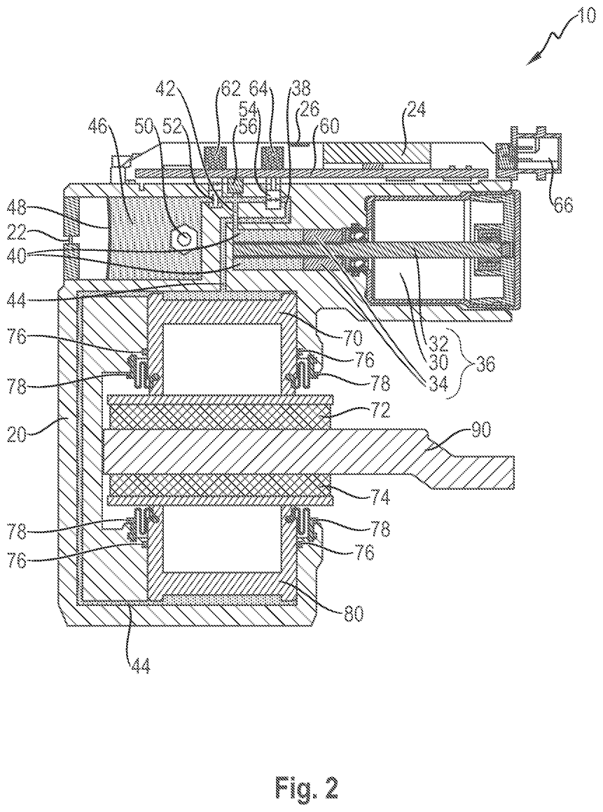

FIG. 2 shows a schematic illustration of an electrohydraulic brake unit 10 for a motor vehicle according to a second embodiment. In the present case, the electrohydraulic brake unit 10 is designed, purely by way of example, as a fixed calliper brake.

The electrohydraulic brake unit 10 is fundamentally designed in a similar manner to the embodiment shown in FIG. 1, but has a further brake piston 80 with the second brake pad 74 arranged thereon. In the present case, the connecting line 42, 44 furthermore supplies brake fluid to both brake pistons 70, 80. The brake piston 70, 80 and the brake pads 72, 74 are arranged symmetrically to the brake disc 90 in such a way that, upon actuation of the brake 10, both brake pads 72, 74 are moved in the direction of the brake disc 90 with equal force. Both brake pads 72, 74 therefore apply a force to the brake disc 90 simultaneously, whereby an even braking effect and even wear on the two brake pads 72, 74 can be achieved.

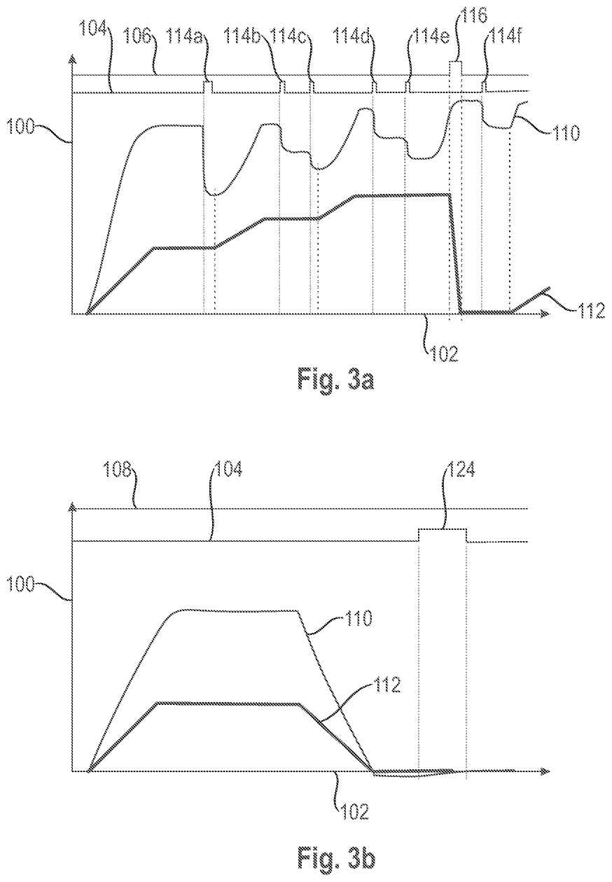

FIGS. 3a and 3b show, in a schematic sequence graph, exemplary operating states of the electrohydraulic brake unit 10 of the first embodiment of FIG. 1, which is designed as a floating calliper brake. The y-axis 100 here shows the increasing piston travel 112 of the piston 34, with the piston 34 contacting the actuator 30 at zero, and the increasing brake pressure 110. The x-axis 102 shows the elapsed time. Likewise depicted are the switching states 104, 106 for the, normally closed, first check valve 52 (NC valve) and the second, normally open, check valve 54 (NO valve). Deviations from the closed position of the first check valve 52 and from the open position of the second check valve 54 are described below with regard to the reference signs 114a-g and 124.

It is furthermore revealed in FIG. 3a that, during the normal operation described above, it is possible to differentiate between a passive operation 114a, a pressure build-up operation 114b and an analogous pressure decrease operation 114c.

The passive operation 114a denotes the idle position of the electrohydraulic brake unit 10, in which neither the brake nor the actuator 30 are actuated. As a result, the brake pressure 110, the piston travel 112 and the piston pressure are zero in each case.

The pressure build-up operation 114b and the analogous pressure decrease operation 114c denote the actual brake application. During the pressure build-up operation 114b, the actuator 30 is activated through the actuation of the brake in such a way that the piston 34 is extended. Consequently, the brake pressure 110 and the piston pressure increase in each case, wherein the piston travel 112 either remains constant or likewise increases. During the analogous pressure decrease operation 114, the actuator 30, after the actuation of the brake has been terminated, is operated in such a way that the piston 34 is retracted. As a result the brake pressure 110 and the piston pressure decrease in each case, wherein the piston travel 112 either remains constant or likewise decreases.

As is furthermore revealed in FIG. 3a, during the alternative operation described above, it is possible to differentiate between a recharging operation following a pressure decrease 114e and a recharging operation in the case of an increased volume requirement 114f.

The recharging operation following a pressure decrease 114e and the recharging operation in the case of an increased volume requirement 114f each take place during a retraction of the piston 34. As a result, fluid is taken from the reservoir 46 in each case, during which the piston pressure is constant, the piston travel 112 converges towards zero and the brake pressure 100 is less than or equal to zero.

In this case, the recharging operation following the pressure decrease 114e denotes the resetting of the piston 34 into its starting position for the particular case of slip control, in which spinning of one or more wheels of the motor vehicle when there is less, or a loss of, grip on the road surface is counteracted by targeted braking prompted by the control unit.

The recharging operation in the case of an increased volume requirement 114f, on the other hand, is only used when brake fluid is lost from the brake circuit, for example and in particular as a result of a leak. The loss may be detected, for example, as a result of the pressure in the brake circuit dropping whilst the brake is in the idle position.

In the case of the pressure equalization operation, it is furthermore possible to differentiate between a rapid pressure decrease operation 114d and a pressure equalization operation in the passive state 116.

The rapid pressure decrease operation 114d is initiated during slip regulation, takes place without actuation of the actuator 30 and requires only a brief opening of the second check valve 54, wherein the brake pressure 110 and the piston pressure drop rapidly in each case and the piston travel 112 remains constant or likewise decreases rapidly.

The pressure equalization operation in the passive state 116 likewise takes place without actuation of the actuator 30 and requires simultaneous opening of both check valves 52, 54 over a time period which is usually longer than, for example, during the passive operation 114a or one of the operations 114b-f. As a result, the brake pressure 110, the piston travel 112 and the piston pressure each drop to zero. Depending on the duration of the opening of both check valves 52, 55, temperature equalization between the connecting line 42, 44, the working chamber 40 and the reservoir 46 and also the environment occurs in addition to pressure equalization. Frictional heat generated during braking, for example, may thus be dissipated effectively to the environment.

In FIG. 3, a regular recharging operation following a pressure decrease 124 is shown purely schematically and by way of example. in contrast to the case mentioned above, the resetting of the piston 34 into its starting position here takes place in response to a maximum pressure threshold value, describing a maximum pressure, being exceeded, or in response to a certain number of brake applications taking place. In contrast to the above-mentioned recharging operation following a pressure decrease 114e, in the present case, the first check valve 52 is open for a time period which is usually longer than during a pressure equalization operation in the passive state 116 and during one of the operations 114b-f. Once a minimum pressure threshold value is not reached, the check valves 52, 54 are subsequently switched back to normal operation. The full braking effect of the electrohydraulic brake unit 10 may thus be provided again in a simple manner.

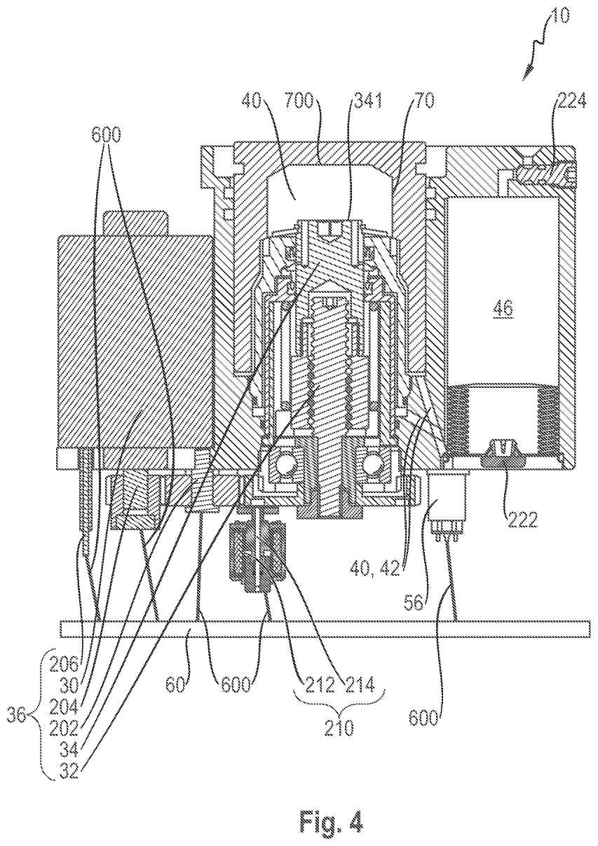

FIG. 4 shows a schematic sectional illustration of an electrohydraulic brake unit 10 for a motor vehicle according to a third embodiment. In the present case, the electrohydraulic brake unit 10 is designed purely by way of example as a floating calliper brake.

The electrohydraulic brake unit 10 in the embodiment shown in FIG. 4 has an actuator 30 designed as a single-acting piston pump, with an electric motor, and a piston 34, which actuator and piston are arranged parallel to one another and adjacent to one another. The actuator 30 is connected to the piston 34 in a force-fitting manner via a gear 202 designed as a ball screw. FIG. 4 furthermore reveals that the piston 34 is partially arranged in the brake piston 70 of the electrohydraulic brake unit 10, which is designed as a floating calliper brake and is operated directly by the actuator 30.

A reservoir 46 having a fill valve 224 and a vent 222 is moreover arranged adjacent to and parallel to the piston 34. The reservoir is in fluidic communication with the working chamber 40 and the brake piston 70 via connecting lines 42, 444. The reservoir 46 moreover has a pressure sensor 56, which ascertains the pressure in the reservoir 46.

The electrohydraulic brake unit 10 moreover has a parking brake, or parking lock, designed as an electromagnet 210. The electromagnet 210 here has a solenoid 212 and a core 214, which is movably arranged in the solenoid. The electromagnet 210 here is arranged on the piston 34 on the spindle side, i.e. adjacent to the gear 202 designed as a ball screw, in such a way that, as a result of applying a current to the solenoid 212, the core 214 of the solenoid 212 moves in a direction parallel to the movement direction of the piston and may be arrested in certain positions other than a bottom dead point. A resetting of the piston to its starting position, i.e. at the bottom dead point, is thus prevented. A brake pressure of the brake fluid present in the working chamber 40 is thus maintained and the brake piston 70 is likewise arrested in a certain position. In this way, the self-locking effect of a parking brake or parking lock may be provided in a simple and cost-effective manner.

FIG. 4 furthermore reveals that the actuator 30 designed as an electric motor has an actuator control 206 and a torque sensor 204. The actuator control 206 and torque sensor 204 enable improved activation of the actuator 30 designed as an electric motor and therefore an optimized braking effect.

As can be seen in FIG. 4, the actuator control 206, the torque sensor 204, a gear control connected to the gear 202, the electromagnet 210 and the pressure sensor 56 can be connected to the vehicle electronics (not shown) via circuit board connections 600 and a circuit board 60, in particular owing to the parallel and adjacent arrangement of the said components. The piston 34, and therefore the brake piston 70 connected thereto in a force-fitting manner, may thus be selectively controlled by the vehicle electronics. The number of electrical components present in the electrohydraulic brake unit 10 may thus be reduced and combined in such a way that the encapsulation and the associated protection of the electrical components are simplified and improved. An integrated brake control is furthermore simplified and optimized.

As a result of the mutually parallel and mutually adjacent arrangement of the actuator 30 and reservoir 46 with respect to the piston 34, it is ultimately possible to reduce the size of the actuator 30 through a suitable choice of gear ratio (purely by way of example 3:1) of the gear 202 and/or through the ratio of the brake piston surface 700 to the piston surface 341 (purely by way of example 8:1). As a result, the electrohydraulic brake unit 10 may be provided in a cost-effective and spatially optimized manner.

### LIST OF REFERENCE SIGNS

10 Electrohydraulic brake unit
20 Housing
22, 26 Diaphragm
24 Cooling unit
30 Actuator
32 Spindle
34 Piston
36 Pressure source
38 Brake circuit
40 Working chamber
42, 44 Connecting line
46 Reservoir
48 Membrane
50 Venting screw
52 First switchable check valve
52 Second switchable check valve
56 Pressure sensor
60 Circuit board
62, 64 Solenoid
66 Connections
68 Housing
70, 80 Brake piston
72, 74 Brake pad
76 Sealing ring
78 Pleat seal
90 Brake disc
100 y-axis
102 x-axis
110 Brake pressure
112 Increasing piston travel
104, 106 Switching states of the first and the second check valve
114a Passive operation
114b Pressure build-up operation
114c Analogous pressure decrease operation
114d Rapid pressure decrease operation
114e Recharging operation following a pressure decrease
114f Recharging operation in the case of an increased volume requirement
116 Pressure equalization operation in the passive state
124 Regular recharging operation following a pressure decrease
202 Gear
204 Torque sensor
206 Actuator control
210 Electromagnet
212 Solenoid
214 Core
222 Vent
224 Fill valve
341 Piston surface
600 Circuit board connections
700 Brake piston surface

1. Electrohydraulic brake unit (10) for a motor vehicle, comprising a pressure source (36) designed as an actuator (30),
at least one brake piston (70, 80), and
a brake circuit (38), which connects the pressure source (36) and the at least one brake piston (70, 80) to one another,
wherein he pressure source (36), the at least one brake piston (70, 80) and the brake circuit (38) are arranged in a wheel brake.

2. Electrohydraulic brake unit (10) according to claim 1, wherein the actuator (30) has a piston (34), which is connected to the actuator (30) in a force-fitting manner and wherein the piston (34) and the actuator (30) are aligned parallel to one another, preferably wherein the piston (34) and the actuator (30) are arranged adjacent to one another, more preferably wherein the piston (34) is at least partially integrated in one of the brake pistons (70, 80).

3. Electrohydraulic brake unit (10) according to claim 1,
comprising a parking brake designed as an electromagnet (210), wherein the electromagnet (210) comprises a solenoid (212) and a core (214), which is movably arranged in the solenoid, wherein the core (214) is designed to prevent the piston (34) from resetting, preferably wherein the core (214) is aligned parallel to the piston (34), and/or
wherein the pressure source (36) has a gear (202) arranged between the actuator (30) and the piston, preferably wherein the actuator (30) is designed as an electric motor, which is provided with a torque sensor (204), and/or
wherein the brake circuit (38) has a working chamber (40), a connecting line (42, 44) and a reservoir (46), wherein the piston (34) is movably arranged in the working chamber (40), wherein the connecting line (42, 44) connects the working chamber (40) to the at least one brake piston (70, 80) and to the reservoir (46), wherein the reservoir (46) and the brake piston are aligned parallel to one another, preferably wherein the reservoir (46) has a vent (222), wherein the vent (222) is arranged adjacent to the piston (34).

4. Electrohydraulic brake unit (10) according to claim 3, comprising a circuit board (60), wherein the piston (34) and the actuator (30) are arranged adjacent to the circuit board (60), preferably wherein the pressure source (36) has an actuator control (206), which is adapted for controlling the actuator (30), and wherein the circuit board (60) is connected to one or more of the electromagnets (201) of the actuator control (206), a control unit of the gear (20), the torque sensor (204), a pressure sensor (56), which is designed to ascertain a brake fluid in the reservoir (46).

5. Electrohydraulic brake unit (10) according to claim 1, wherein the actuator (30) has a piston (34) and the brake circuit (38) has a working chamber (40) and a connecting line (42, 44), wherein the piston (34) is movably arranged in the working chamber (40), wherein the connecting line (42, 44) connects the working chamber (40) to the at least one brake piston (70, 80).

6. Electrohydraulic brake unit (10) according to claim 5, wherein the brake circuit (38) has a reservoir (46) and a first switchable check valve (52), wherein the connecting line (42, 44) has a second switchable check valve (54), by means of which the working chamber (40) can be uncoupled from the at least one brake piston (70, 80), wherein the reservoir (46) can be uncoupled from the connecting line (42, 44) by means of the first switchable check valve (52) at a point between the second switchable check valve (54) and the working chamber (40).

7. Electrohydraulic brake unit (10) according to claim 6, wherein the reservoir (46) is designed as a low pressure reservoir.

8. Electrohydraulic brake unit (10) according to claim 7, comprising a circuit board (60), on which a pressure sensor (56), the first switchable check valve (52, 54) and the second switchable check valve (54) are arranged, wherein the connecting line (42, 44) comprises the pressure sensor (56) for determining a pressure in the connecting line (42, 44).

9. Electrohydraulic brake unit (10) according to claim 1, wherein the connecting line (42, 44) has a pressure sensor (56) for determining a pressure in the connecting line (42, 44).

10. Electrohydraulic brake unit (10) according to claim 1, wherein the electrohydraulic brake unit (10) is designed as a floating calliper brake or a fixed calliper brake.

11. Electrohydraulic brake unit (10) according to claim 1, wherein the electrohydraulic brake unit (10) is designed as a closed system.

12. Vehicle, comprising an electrohydraulic brake unit (10) according to claim 1.

13. Vehicle according to claim 12, wherein each wheel of the vehicle is supplied with the electrohydraulic brake unit (10).

14. Method for activating the electrohydraulic brake unit (10) according to claim 5, comprising:
(i) carrying out a normal operation, in which the first check valve (52) is closed and the second check valve (54) is open, wherein the normal operation is adapted for achieving a braking effect,
(ii) carrying out an alternative operation in response to a first pressure threshold value being exceeded, in which the first check valve (52) is open and the second check valve (54) is closed, wherein the alternative operation is adapted for resetting the piston (34), whereby the piston (34) contacts the actuator (30), and
(iii) carrying out the normal operation in response to a second pressure threshold value not being reached, wherein the second pressure threshold value is lower than the first pressure threshold value.
